(19) United States
(12) Patent Application Publication
(10) Pub. No.: US 2012/0013903 A1
(43) Pub. Date: Jan. 19, 2012

(54) NANOWIRE LIGHT CONCENTRATORS FOR PERFORMING RAMAN SPECTROSCOPY

(76) Inventors: Huei Pei Kuo, Cupertino, CA (US); Shih-Yuan Wang, Palo Alto, CA (US); David A. Fattal, Mountain View, CA (US); Jingjing Li, Palo Alto, CA (US); Nobuhiko Kobayashi, Sunnyvale, CA (US); Zhiyong Li, Redwood City, CA (US)

(21) Appl. No.: 13/258,391

(22) PCT Filed: Jul. 30, 2009
(86) PCT No.: PCT/US2009/052288

§ 371 Date: Sep. 21, 2011

(51) Int. Cl. G01J 3/44; B82Y 20/00; B82B 1/00

(52) U.S. Cl. 356/301; 977/762; 977/949

(57) ABSTRACT

Embodiments of the present invention are directed to systems for performing surface-enhanced Raman spectroscopy. In one embodiment, a system (100, 400, 600, 800, 900, 950) for performing Raman spectroscopy comprises a substrate (102) substantially transparent to a range of wavelengths of electromagnetic radiation and a plurality of nanowires (104, 602) disposed on a surface of the substrate. The nanowires are substantially transparent to the range of wavelengths of electromagnetic radiation. The system includes a material disposed on each of the nanowires. The electromagnetic radiation is transmitted within the substrate, into the nanowires, and emitted from the ends of the nanowires to produce enhanced Raman scattered light from molecules located on or in proximity to the material.

### STATEMENT OF GOVERNMENT INTEREST

This invention has been made with Government support under Contract No. HR0011-09-3-0002, awarded by the Defense Advanced Research Projects Agency. The government has certain rights in the invention.

### TECHNICAL FIELD

Embodiments of the present invention relate generally to systems for performing surface-enhanced Raman spectroscopy.

### BACKGROUND

Raman spectroscopy is a spectroscopic technique used in condensed matter physics and chemistry to study vibrational, rotational, and other low-frequency modes in molecular systems. In a Raman spectroscopic experiment, an approximately monochromatic beam of light of a particular wavelength range passes through a sample of molecules and a spectrum of scattered light is emitted. The spectrum of wavelengths emitted from the molecule is called a “Raman spectrum” and the emitted light is called “Raman scattered light,” A Raman spectrum can reveal electronic, vibrational, and rotational energies levels of a molecule. Different molecules produce different Raman spectrums that can be used like a fingerprint to identify molecules and even determine the structure of molecules.

The Raman scattered light generated by a compound (or ion) adsorbed on or within a few nanometers of a structured metal surface can be 10³-10⁶ times greater than the Raman scattered light generated by the same compound in solution or in the gas phase. This process of analyzing a compound is called surface-enhanced Raman spectroscopy (“SERS”) In recent years, SERS has emerged as a routine and powerful tool for investigating molecular structures and characterizing interfacial and thin-film systems, and even enables single-molecule detection. Engineers, physicists, and chemists continue to seek improvements in systems and methods for performing SERS.

### BRIEF DESCRIPTION OF THE DRAWINGS

FIG. 1A shows an isometric view of a Raman-active system configured in accordance with embodiments of the present invention.

FIG. 1B shows a cross-sectional view the Raman-active system along a line A-A, shown in FIG. 1A, in accordance with embodiments of the present invention.

FIG. 2 shows height and taper angle of a tapered nanowire configured in accordance with embodiments of the present invention.

FIG. 3A shows a cross-sectional view of the Raman-active system along the line A-A, shown in FIG. 1A, under back illumination in accordance with embodiment of the present invention.

FIG. 3B shows internal reflection within two tapered nanowires disposed on a portion of a substrate in accordance with embodiments of the present invention.

FIG. 4A shows an isometric view of a Raman-active system configured in accordance with embodiments of the present invention.

FIG. 4B shows a cross-sectional view of the Raman-active system along a line B-B, shown in FIG. 4A, in accordance with embodiments of the present invention.

FIG. 5A shows a cross-sectional view of the Raman-active system along the line B-B, shown in FIG. 4A, under front illumination in accordance with embodiment of the present invention.

FIG. 5B shows internal reflection within two tapered nanowires disposed on a portion of a substrate in accordance with embodiments of the present invention.

FIG. 6A shows an isometric view of a Raman-active system configured in accordance with embodiments of the present invention.

FIG. 6B shows a cross-sectional view of the Raman-active system along a line C-C, shown in FIG. 6A, in accordance with embodiments of the present invention.

FIG. 7A shows a cross-sectional view of the Raman-active system along the hue C-C, shown in FIG. 6A, under hack illumination in accordance with embodiment of the present invention.

FIG. 7B shows internal reflection within two column-shaped nanowires disposed on a portion of a substrate in accordance with embodiments of the present invention.

FIG. 8A shows a side view of a Raman-active system configured in accordance with embodiment of the present invention.

FIG. 8B shows internal reflection within two column-shaped nanowires disposed on a portion of a substrate in accordance with embodiments of the present invention.

FIG. 9A shows an isometric view of a Raman-active system comprising a combination of tapered and column-shaped nanowires in accordance with embodiments of the present invention.

FIG. 9B shows an isometric view of a Raman-active system comprising a combination of tapered and column-shaped nanowires and having a reflective layer in accordance with embodiments of the present invention.

FIG. 10A shows an example of Raman-active nanoparticles disturbed over the outer surface of a tapered nanowire in accordance with embodiments of the present invention.

FIG. 10B shows an example of Raman-active nanoparticles distributed over the outer surface of a column-shaped nanowire in accordance with embodiments of the present invention.

FIG. 11 shows a side-view of tapered nanowires and substrate configured for back illumination and operated in accordance with embodiments of the present invention to produce a Raman spectrum.

FIG. 12 shows an example Raman spectrum.

FIG. 13 shows a schematic representation of a back illumination analyte sensor configured in accordance with embodiments of the present invention.

FIG. 14 shows a schematic representation of a front illumination analyte sensor configured in accordance with embodiments of the present invention.

### DETAILED DESCRIPTION

Embodiments of the present invention are directed to systems for performing surface-enhanced Raman spectroscopy. The systems include an array of nanowires disposed on a substrate. The nanowires can be tapered or column-shaped and are at least partially transparent to the wavelengths of the Raman excitation light and emitted Raman scattered light. The systems are configured so that the Raman excitation light can enter the nanowires through the substrate and be guided and concentrated by internal reflection toward the tip of the nanomires where the light exits. A portion of the outer surface of the nanowires is coated with a Raman-active material so molecules located on, or in close proximity to, the coated portions of the nanowire produce enhanced Raman scattered light.

The term “light” as used to describe the operation of system embodiments of the present invention is not intended to be limited to electromagnetic radiation with wavelengths that lie only within the visible portion of the electromagnetic spectrum, but is intended to also include electromagnetic radiation with wavelengths outside the visible portion, such as the infrared and ultraviolet portions of the electromagnetic spectrum, and can be used to refer to both classical and quantum electromagnetic radiation.

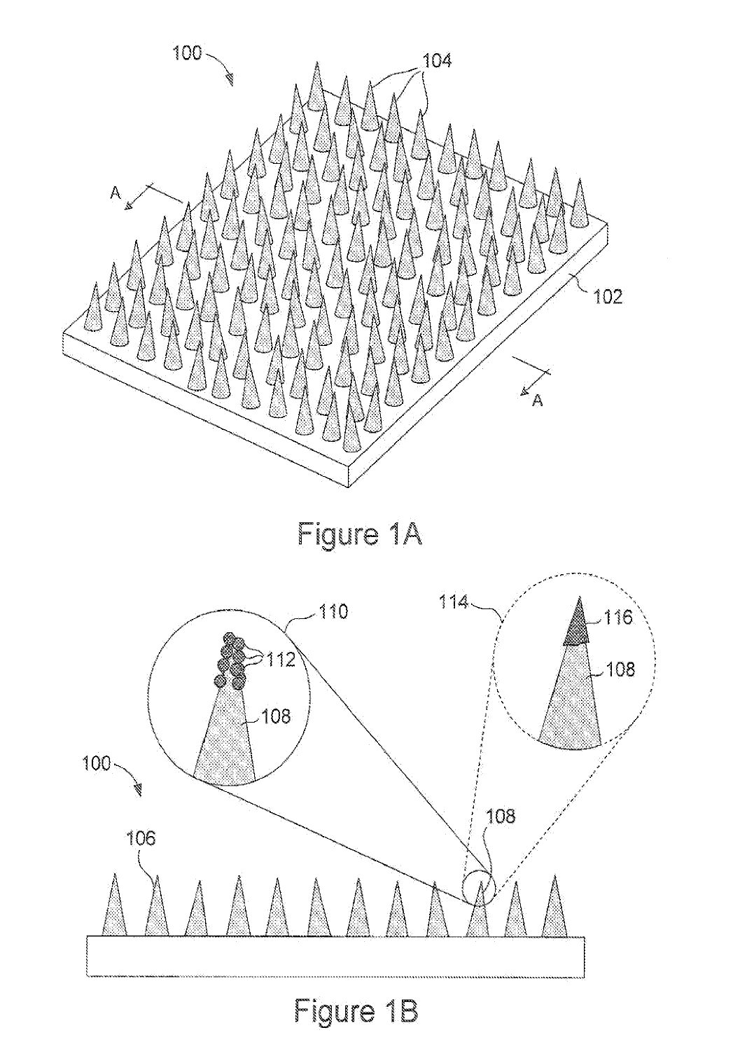

FIG. 1A shows an isometric view of a Raman-active system 100 configured in accordance with embodiments of the present invention. The system 100 includes a substrate 102 and a plurality of tapered nanowires 104 disposed on a surface of the substrate 102. As shown in the example of FIG. 1A, nanowires 104 may be randomly distributed over the surface of the substrate, and, in this embodiment, the nanowires are tapered with tapered ends, or tips, directed away from the substrate 102.

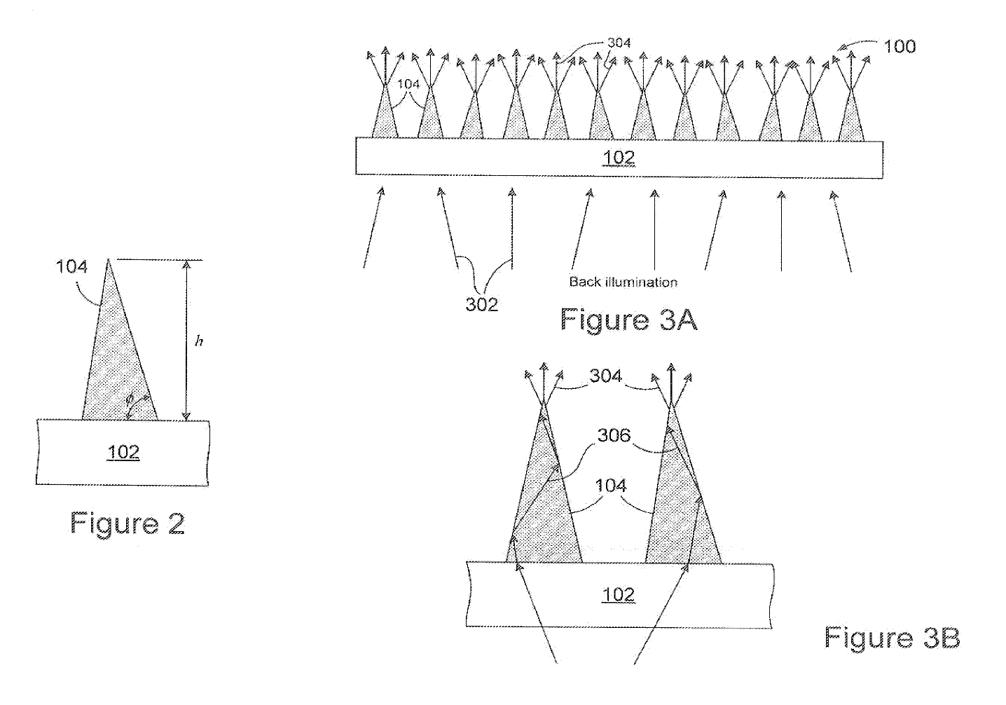

FIG. 1B shows a cross-sectional view of the system 100 along a line A-A, shown in FIG. 1A, in accordance with embodiments of the present invention. In the example of FIG. 18, the tapered nanowires 104 may have a nearly symmetric inverted-cone shape, such as tapered nanowire 106, or an asymmetric inverted-cone shape, such as tapered nanowire 108. The outer surfaces of the nanowires can be coated with a Raman active material. In certain embodiments, the Raman-active material can be in the form of Raman-active nanoparticles disposed near the tip of the nanowires. In FIG. 18, the end of tapered nanowire 108 is magnified in an enlargement 110 revealing a number of Raman-active nanoparticles 112 disposed on the outer surface, near the tip, of the nanowire 108. In other embodiments, the Raman-active material can be in the form of a Raman-active layer disposed on at least a portion of the outer surface, near the tip, of the nanowires. FIG. 1B also shows an enlargement 114 of the nanowire 108 with the tip of the nanowires partially coated with a Raman-active layer 116. As shown in FIG. 2, the height h of the nanowires can range from less than 0.1 to about 6 μm. The taper angle φ can range from about 2° to about 45° or larger.

The Raman-active system 100 is configured for back illumination with Raman excitation light. In other words, the surface of the substrate opposite the surface upon which the nanowires are disposed is illuminated with Raman excitation light, a portion of which is transmitted through the substrate 102 and into the nanowires 104. FIG. 3A shows a cross-sectional view of the Raman-active system 100 along line A-A, shown in FIG. 1A, under back illumination in accordance with embodiment of the present invention. As shown in the example of FIG. 3A, the substrate 102 and nanowires 104 are composed of materials and configured so that Raman excitation light entering the substrate 102 opposite the nanowires, represented by rays 302, is transmitted through the substrate 102 and at least a portion of the light is transmitted into the nanowires 104. The nanowires 104 are configured so that a substantial portion of the light transmitted into the nanowires 104 is directed toward the tips, where the light exits the nanowires 104, as indicated by rays 304.

FIG. 3B shows an enlarged cross-sectional view of two nanowires 104 disposed on a portion of the substrate 102 in accordance with embodiments of the present invention. Because the refractive index of the nanowires is greater than the surrounding air, a substantial portion of the Raman excitation light entering the nanowires can be internally reflected, as represented by rays 306, and exit the nanowires 104 near the tips.

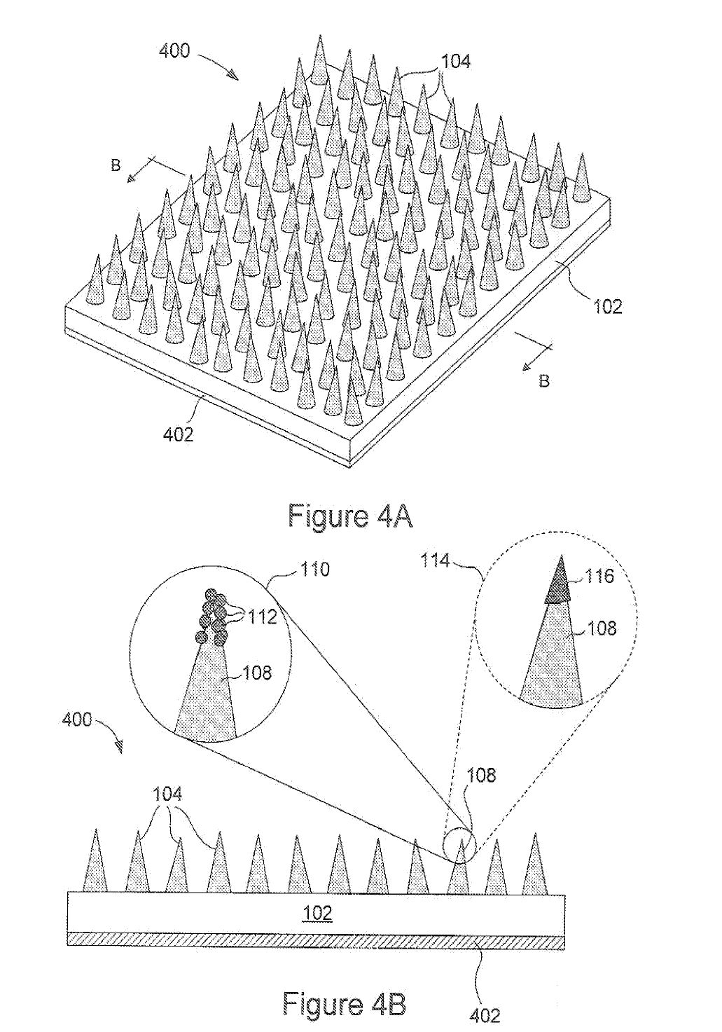

FIG. 4A shows an isometric view of a Raman-active system 400 configured in accordance with embodiments of the present invention. FIG. 4B shows a cross-sectional view of the Raman-active system 400 along a line B-B, shown in FIG. 4A, in accordance with embodiments of the present invention. As shown in the example of FIGS. 4A-4B, the system 400 is nearly identical to the system 100 described above with reference to FIG. 1 except the system 400 includes a reflective layer 402 disposed on a surface of the substrate 102 opposite the surface upon which the nanowires 104 are disposed.

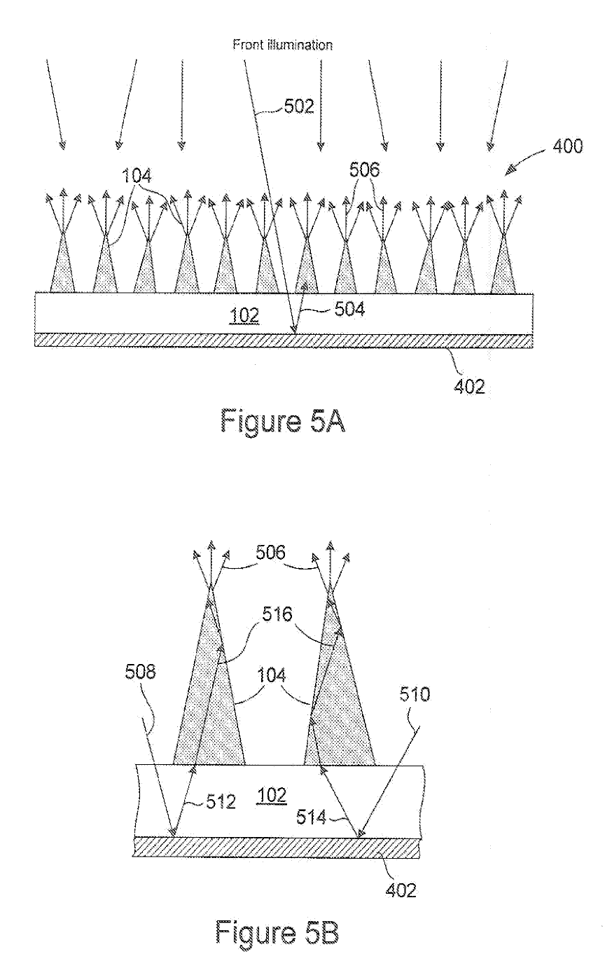

Unlike the Raman-active system 100, which is configured for back illumination, the Raman-active system 400 is configured for front illumination. In other words, the Raman-active system 400 can be illuminated with Raman excitation light that enters the substrate 102 through the same surface upon which the nanowires are disposed. FIG. 5A shows a cross-sectional view of the Raman-active system 400 along line B-B, shown in FIG. 4A, under front illumination in accordance with embodiment of the present invention. As shown in the example of FIG. 5A, the nanowires 104 and exposed surface of the substrate 102 are illuminated with Raman excitation light. The light strikes the nanowires 104 and the Raman-active materials (not shown). FIG. 5A includes rays 502 and 504 that represent a path of a ray of light transmitted between the nanowires 104 into the substrate 102. The ray of light is reflected off of the reflective layer 404 back through the substrate 102 and into the nanowires 104. As described above with reference to FIG. 3, the nanowires 104 are configured so that a substantial portion of the light transmitted into the nanowires 104 is directed toward the tips of the nanowires, where the light exits the nanowires 104, as indicated by rays 506.

FIG. 5B shows an enlarged cross-sectional view of two nanowires 104 of the Raman-active system 400 in accordance with embodiments of the present invention. Rays 508 and 510 represent rays of light entering the substrate 102 under front illumination, and rays 512 and 514 represent the path of light reflected off of the reflective surface 402 and into the nanowires 104. As described above, because the refractive index of the nanowires 104 is greater than the surrounding air, a substantial portion of the Raman excitation light entering the nanowires 104 is internally reflected, as represented by rays 516, and exits the nanowires 104 near the tips.

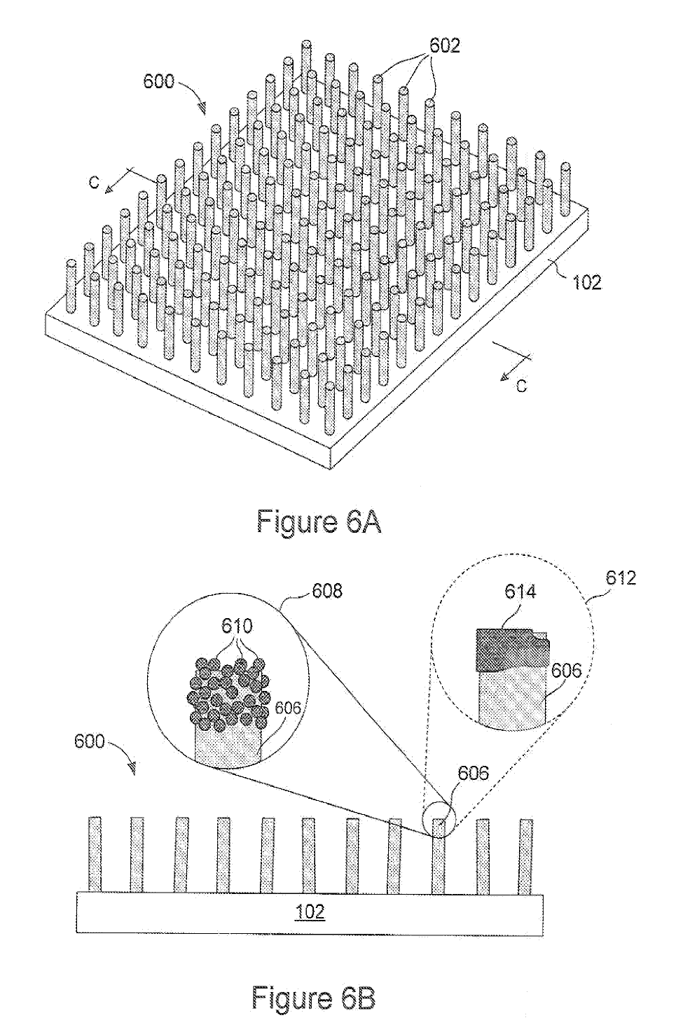

Embodiments of the present invention are not limited to Raman-active systems comprising, tapered nanowires. In other embodiments, the nanowires can be column shaped. FIG. 6A shows an isometric view of a Raman-active system 600 configured in accordance with embodiments of the present invention. The system 600 includes the substrate 102 and a plurality of randomly distributed, column-shaped nanowires 602 disposed on a surface of the substrate 102. The heights of the nanowires can range from less than 0.1 to about 6 μm. The diameter of the nanowires can range from about 10 to about 200 nm. Tapered nanowires could have a tip diameter of a few nanometers.

FIG. 6B shows a cross-sectional view of the system 600 along a line C-C, shown in FIG. 6A, in accordance with embodiments of the present invention. In the example of FIG. 6B, the outer surfaces of the nanowire ends can be coated with a Raman-active material. In certain embodiments, the Raman-active material can be in the form of Raman-active nanoparticles disposed near the ends of the nanowires. In FIG. 6B, the end of nanowire 606 is magnified in an enlargement 608 revealing a number of Raman-active nanoparticles 610 disposed on the outer surface, near the end, of the nanowire 606. In other embodiments, the Raman-active material can be in the form of a Raman-active layer disposed on at least a portion of the outer surface, near the end, of the nanowires. FIG. 6B also shows an enlargement 612 of the nanowire 606 with the end of the nanowire 606 partially coated with a Raman-active layer 614.

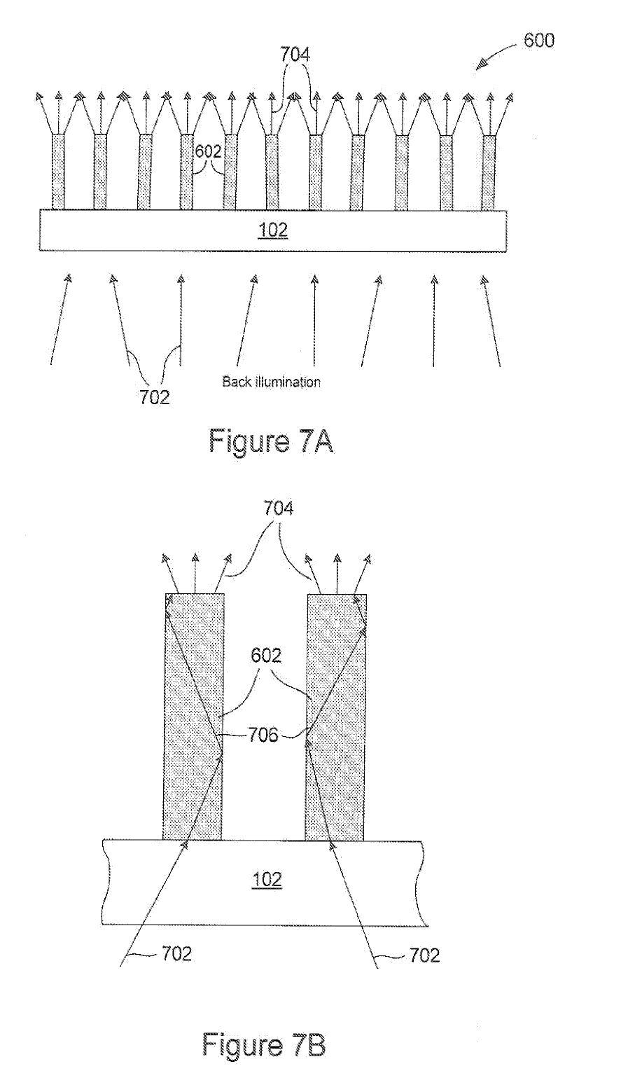

Like the Raman-active system 100, the Raman-active system 600 is also configured for back illumination. The surface opposite the surface on which the nanowires 602 are disposed is illuminated with Raman excitation light that is transmitted through the substrate 102 into the nanowires 602. FIG. 7A shows a cross-sectional view of the Raman-active system 600 along line C-C, shown in FIG. 6A, under back illumination in accordance with embodiment of the present invention. As shown in the example of FIG. 7A, Raman excitation light enters the substrate 102, represented by rays 702, and is transmitted through the substrate 102 where at least a portion of the light is transmitted into the nanowires 602. The nanowires 602 direct the light toward the tips, where the light exits the nanowires 602, as indicated by rays 704.

FIG. 7B shows an enlarged cross-sectional view of two nanowires 602 disposed on a portion of the substrate 102 in accordance with embodiments of the present invention. Because the refractive index of the nanowires 602 is greater than the surrounding air, a substantial portion of the Raman excitation light entering the nanowires is internally reflected, as represented by rays 706, and exits the nanowires 602 near the tips.

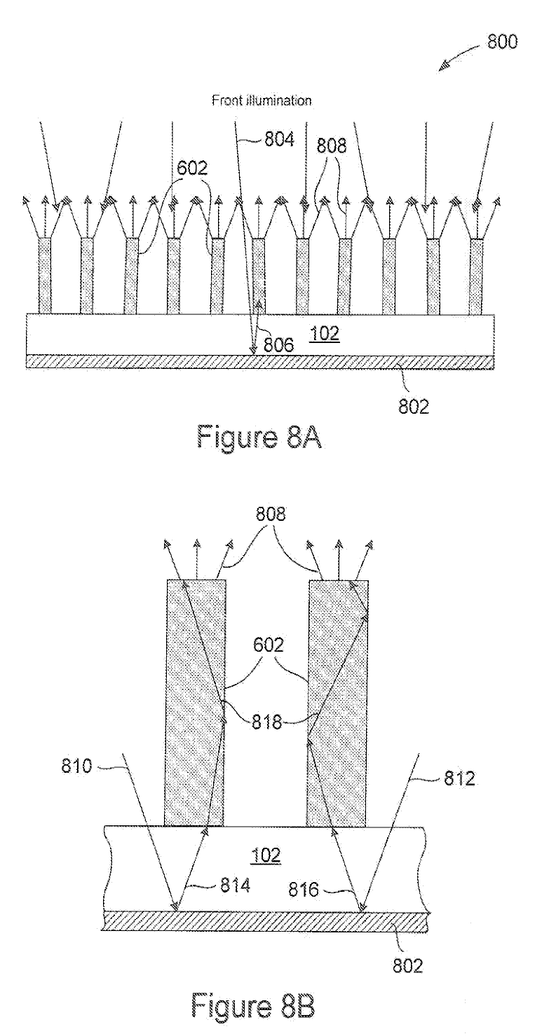

In other embodiments, a reflective layer can be disposed on the surface of the substrate 102 of the Raman-active system 600 as described above for the Raman-active system 400 FIG. 8A shows a side view of a Raman-active system 800 configured in accordance with embodiment of the present invention. The Raman-active system 800 is nearly identical to the Raman-active system 600 except a reflective layer 802 is disposed on the surface of the substrate 102 opposite the nanowires. As shown in the example of FIG. 8A Raman-active system 800 is front illuminated. In other words, the nanowires 602 and exposed surface of the substrate 102 are illuminated with Raman excitation light. The light strikes the nanowires 602 and the Raman-active materials (not shown). Rays 804 and 806 represent a path of a ray of light transmitted between the nanowires 602 into the substrate 102, where the light is reflected off of the reflective layer 802 back through the substrate 102 and into the nanowires 602. As described above with reference to FIG. 7A, the nanowires 602 are configured so that a substantial portion of the light transmitted into the nanowires 602 is directed toward the ends of the nanowires, where the light exits the nanowires 602, as indicated by rays 808.

FIG. 8B shows an enlarged cross-sectional view of two nanowires 602 of the Raman-active system 800 in accordance with embodiments of the present invention. Rays 810 and 812 represent light entering the substrate 102, and rays 814 and 816 represent the path of light reflected off of the reflective surface 802 and into the nanowires 602. As described above, because the refractive index of the nanowires 602 is greater than the surrounding air, a substantial portion of the Raman excitation light entering the nanowires 602 is internally reflected, as represented by rays 818, and exits the nanowires 602 near the ends.

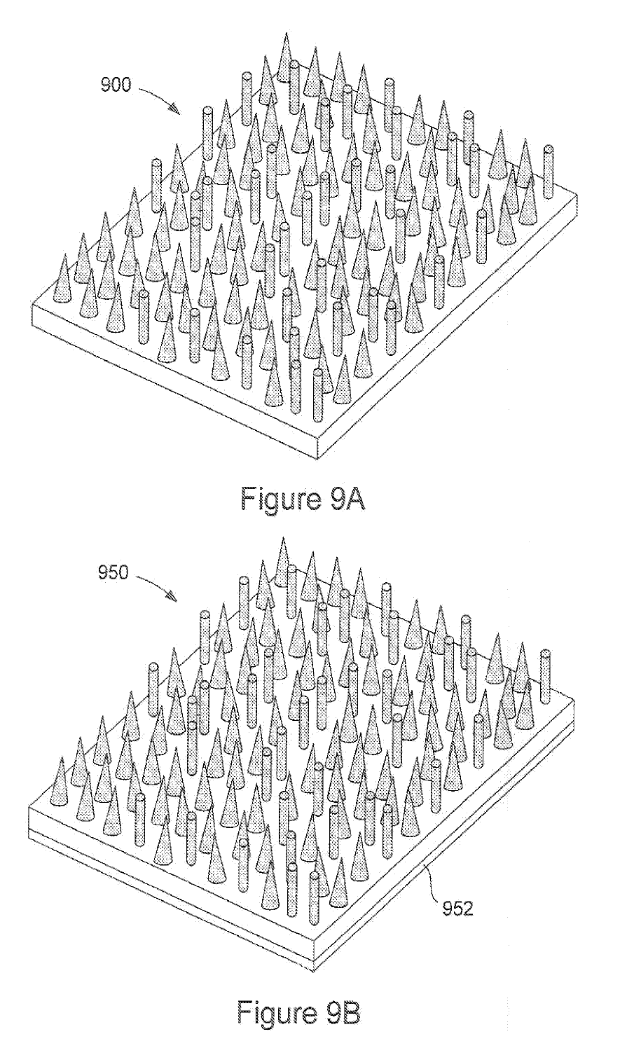

Embodiments of the present invention are not limited to Raman-active systems having only tapered nanowires or only column-shaped nanowires. In other embodiments, the nanowires of a Raman-active systems can be a combination of tapered and column-shaped nanowires. FIG. 9A shows an isometric view of a Raman-active system 900 comprising a combination of tapered and column-shaped nanowires in accordance with embodiments of the present invention. The Raman-active system 900 is configured for back illumination as described above with reference to Raman-active systems 100 and 600. FIG. 9B shows an isometric view of a Raman-active system 950 also comprising a combination of tapered and column-shaped nanowires in accordance with embodiments of the present invention. Unlike the Raman-active system 900, the Raman-active system 950 includes a reflective layer 952 and is suitable for front illumination, as described above with reference to Raman-active systems 400 and 800.

The substrate 102 can be composed of a substantially transparent dielectric material, including glass, SiO₂, Al₂O₃, transparent dielectric polymers, or any other suitable material for transmitting the wavelengths comprising the Raman excitation light. The Raman-active system nanowires can be composed of materials that are at least partially transparent to the wavelengths comprising the Raman excitation light. For example, the nanowires can be composed of glass in order to transmit Raman excitation wavelengths in the visible portion of the electromagnetic spectrum. The nanowires can be composed of silicon (“Si”) in order to transmit Raman excitation wavelengths in the infrared portions of the electromagnetic spectrum. The nano ii can also be composed of quarts, glass, or Al₂O₃ in order to transmit Raman excitation wavelengths in the ultraviolent portion of the electromagnetic spectrum.

The nanowires can be formal using a vapor-liquid-solid (“VLS”) chemical synthesis process. This method typically involves depositing particles of a catalyst material such as gold or titanium on a surface of the substrate 102. The substrate 102 is placed in a chamber and heated to temperatures typically ranging between about 250° C. to about 1000° C. Precursor gasses including elements or compounds that will be used to form the nanowires are introduced into the chamber. The particles of the catalyst material cause the precursor gasses to at least partially decompose into their respective elements, some of which are transported on or through the particles of catalyst material and deposited on the underlying surface. As this process continues, nanowires grow with the catalyst particle remaining on the tip or end of the nanowires. Nanowires can also be formed by physical vapor deposition or by surface atom migration. In addition, nanowires can be formed by reactive etching techniques with or without lithographic defined masking patterns. The nanowires can also be formed by nanoimprint lithography, soft print lithography or an embossing technique with a pre-patterned template.

The Raman-active material comprising the Raman-active particles and Raman-active layers deposited on the nanowires can be composed of silver (“Ag”), gold (“Au”), copper (“Cu”) or another metal suitable for forming a structured metal surface.

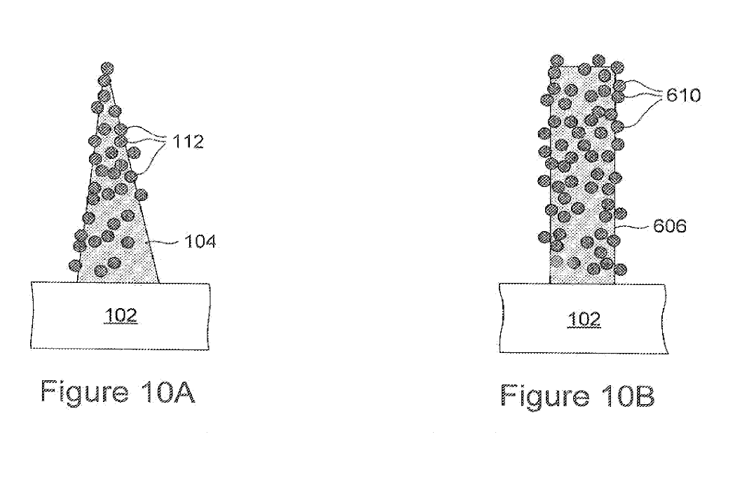

Embodiments of the present invention are not limited to the Raman-active material being located primarily at the ends of tips of the nanowires. In other embodiments, the Raman-active material can be distributed over the outer surface of the nanowires. FIG. 10A shows an example of Raman-active nanoparticles 110 disturbed over the outer surface of a tapered nanowire 104 in accordance with embodiments of the present invention. FIG. 10B shows an example of Raman-active nanoparticles 610 distributed over the outer surface of a column-shaped nanowire 606 in accordance with embodiments of the present invention.

The Raman-active systems 100, 400, 600, 800, 900 and 950 can be used to identify one or more analyte molecules by selecting the composition of the tapered nanowire to transmit the appropriate wavelength of Raman excitation light that causes the analyte disposed on, or located in close proximity to, the nanowires to produce associated Raman scattered light. An analyte disposed on or located in close proximity to the Raman-active material disposed on the nanowires enhances the intensity of the Raman scattered light when illuminated by the Raman excitation wavelengths. The Raman scattered light can be detected to produce a Raman spectrum that can be used like a finger print to identify the analyte.

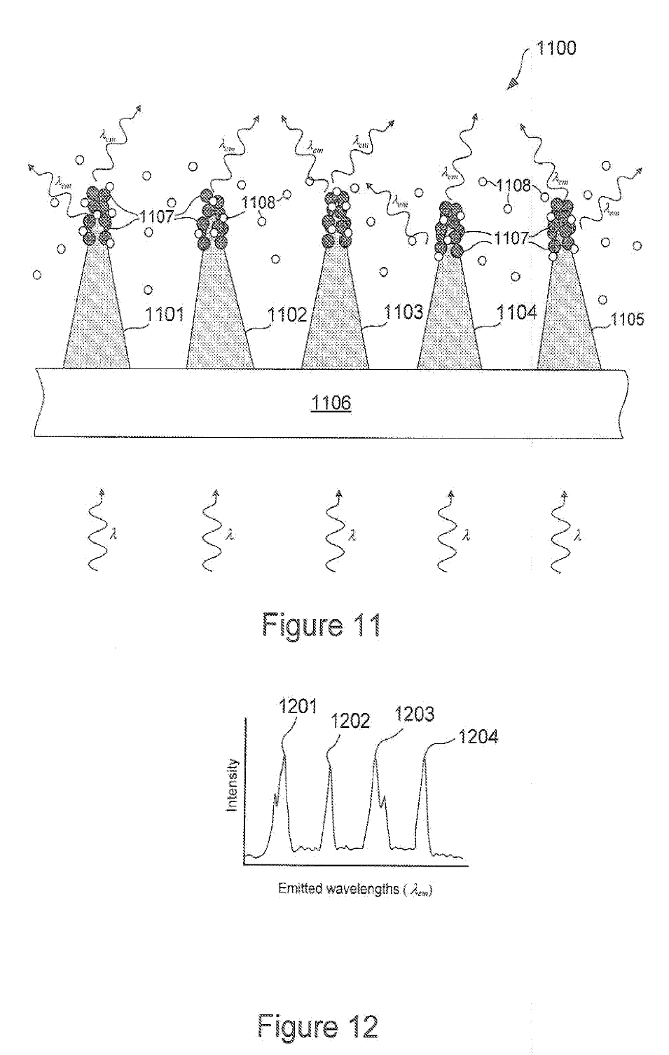

FIG. 11 shows a side-view of five tapered nanowires 1101-1105 and a substrate 1106 portion of a Raman-active system 1100 configured for back illumination and operated in accordance with embodiments of the present invention to produce a Raman spectrum. As shown in the example of FIG. 11, the Raman-active system 1106 includes Raman-active nanoparticles 1107 located at the tips of the nanowires. An analyte 1108 is introduced and Raman excitation light of suitable wavelengths for generating Raman scattered light from the analyte is transmitted into the substrate. As described above with reference to FIGS. 3A and 3D, the light is transmitted through the substrate 1106 and a portion of the light enters the nanowires 1101-1105. A portion of the light entering, the nanowires is substantially confined within the nanowires 1101-1105, concentrated, and guided by internal reflection toward the tips. The wavelength range of Raman excitation light cause the analyte 1108 located near the tips of the nanowires 1101-1105 to emit a Raman spectrum of Raman scattered light over a range wavelengths denoted by λ_{cm}. The intensity of the Raman scattered light may also be enhanced as a result of two mechanisms. The first mechanism is an enhanced electromagnetic field produced at the surface of the Raman-active nanoparticles 1107. As a result, conduction electrons in the metal surfaces of the nanoparticles 1107 are excited into an extended surface excited electronic state called a “surface plasmon polariton.” Analytes 1108 adsorbed on or in close proximity to the nanoparticles 1107 experience a relatively strong electromagnetic field. Molecular vibrational modes directed normal to the nanoparticle 1107 surfaces are most strongly enhanced. The intensity of the surface plasmon polariton resonance depends on many factors including the wavelengths of the Raman excitation light. The second mode of enhancement, charge transfer, may occur as a result of the formation of a charge-transfer complex between the surfaces of the nanoparticles 1107 and the analyte 1108 absorbed to these surfaces. The electronic transitions of many charge transfer complexes are typically in the visible range of the electromagnetic spectrum. In other embodiments, an external electric field can also be applied to concentrate the analyte around the tips or ends of the nanowires where the field is the strongest.

FIG. 12 shows an example Raman spectrum associated with Raman scattered light. In the example of FIG. 5, the Raman spectrum comprises four intensity peaks 1201-1204, each peak corresponding to a particular wavelength emitted from an excited analyte. The intensity peaks 1201-1204 and associated wavelengths can be used like a finger print to identify the analyte.

The Raman-active system 1100 represents an example of how the Raman-active systems 100 can be operated. The Raman-active systems 400, 600, and 800 can be operated in the same manner to produce enhanced Raman scattered light, except in the case of the front illuminated Raman-active systems 400 and 800, the Raman excitation light is applied to the side of the systems where the nanowires are located, as described above with reference to FIGS. 4 and 8.

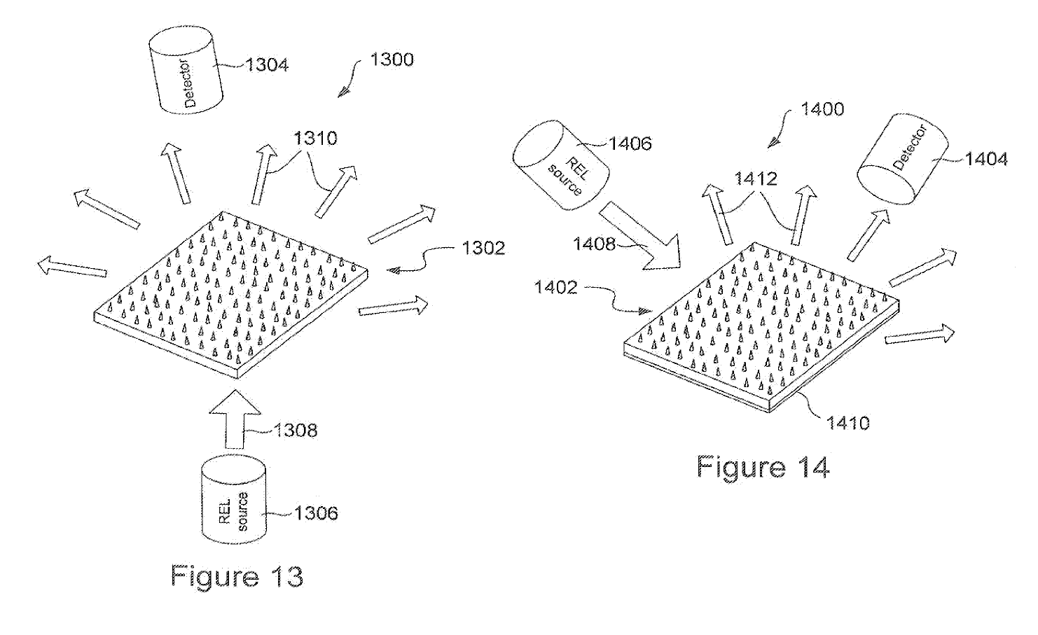

Raman-active systems configured in accordance with embodiments of the present invention can be used in analyte sensors. FIG. 13 shows a schematic representation of a back illumination analyte sensor 1100 configured in accordance with embodiments of the present in invention. The sensor 1300 includes a Raman-active system 1302, configured as described above with reference to Raman-active systems 100, 600, and 900, a photodetector 1304, and a Ramen excitation light source 1306. As shown in the example of FIG. 13, the light source 1306 and the photodetector 1304 are positioned on opposite sides of the system 1302. The light source 1306 is positioned to provide back illumination of the system 1302. A portion of Raman excitation light 1308 is transmitted through the substrate of the system 1302 and into the nanowires to interact with the analyte, as described above with reference to FIG. 11, producing Raman scattered light 1310 that can be detected by photodetector 1304.

FIG. 14 shows a schematic representation of a front illumination analyte sensor 1400 configured in accordance with embodiments of the present invention. The sensor 1400 includes a Raman-active system 1402, configured as described above with reference to Raman-active systems 400, 800, and 950, a photodetector 1404, and a Raman excitation light source 1406. As shown in the example of FIG. 14, the light source 1406 and the photodetector 1404 are positioned on the same side of the system 1402. The light source 1406 is positioned to provide front illumination of the system 1302. A portion of the Raman excitation light 1408 is transmitted into the substrate of the system 1402 and reflected off of a reflective layer 1410 into the nanowires to interact with an analyte, as described above with reference to FIG. 11, producing Raman scattered light 1412 that can be detected by photodetector 1404.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A system (100,400,600,800,900,950) for performing Raman spectroscopy comprising:
a substrate (102) substantially transparent to a range of wavelengths of electromagnetic radiation;
a plurality of nanowires (104,602) disposed on a surface of the substrate, the nanowires substantially transparent to the range of wavelengths of electromagnetic radiation; and
a material disposed on each of the nanowires, wherein the electromagnetic radiation is transmitted within the substrate, into the nanowires, and emitted from the ends of the nanowires to produce enhanced Raman scattered light from molecules located on or in proximity to the material.

2. The system of claim 1 further comprising a reflective layer (402,802) disposed on a surface of the substrate opposite the surface upon which the nanowires are disposed, wherein the electromagnetic radiation is applied to the system so that the radiation enters the substrate through the same surface upon which the nanowires are disposed, is reflected off of the reflective layer into the nanowires, and is emitted from the ends of the nanowires to produce enhanced Raman scattered light from molecules located on or in proximity to the material.

3. The system of claim 1 wherein the nanowires further comprises at least one of tapered nanowires (104) and column-shaped nanowires (602).

4. The system of claim 1 wherein the material disposed on each of the nanowires further comprises nanoparticles (112,610) disposed on the nanowires.

5. The system of claim 1 wherein the material disposed on each of the nanowires further comprises a layer (116,614) disposed on at least a portion of the nanowires.

6. The system of claim 1 wherein the material disposed on each of the nanowires further comprises gold, silver, copper, or another suitable metal for forming surface plasmon polaritons when illuminated by the electromagnetic radiation.

7. The system of claim 1 wherein the nanowires range in height from less than 0.1 μm to about 6 μm.

8. An analyte sensor comprising:
an electromagnetic radiation source (1306,1406) configured to mit a range of wavelengths of electromagnetic radiation;
a system (1302,1402) for performing enhanced Raman spectroscopy including:
a substrate substantially transparent to the range of wavelengths of electromagnetic radiation,
a plurality of nanowires disposed on a surface of the substrate, the nanowires substantially transparent to the range of wavelengths of electromagnetic radiation, and
a material disposed on each of the nanowires, wherein the electromagnetic radiation is transmitted within the substrate, into the nanowires, and emitted from the ends of the nanowires to produce enhanced Raman scattered light from molecules located on or in proximity to the material; and
a photodetector (1304,1404) configured to detect the Raman scattered light.

9. The system of claim 8 further comprising a reflective layer (1410) disposed on a surface of the substrate opposite the surface upon which the nanowires are disposed, wherein the electromagnetic radiation is applied to the system so that the radiation enters the substrate through the same surface upon which the nanowires are disposed is reflected off of the reflective layer into the nanowires, and is emitted from the ends of the nanowires to produce enhanced Raman scattered light from molecules located on or in proximity to the material.

10. The system of claim 8 wherein the nanowires further comprises at least one of tapered nanowires and column-shaped nanowires.

11. The system of claim 8 wherein the material disposed on each of the nanowires further comprises nanoparticles disposed on the nanowires.

12. The system of claim 8 wherein the material disposed on each of the nanowires further comprises a layer disposed on at least a portion of the nanowires.

13. The system of claim 8 wherein the material disposed on each of the nanowires further comprises gold, silver, copper, or another suitable metal for forming surface plasmon polaritons.

14. The system of claim 8 wherein the electromagnetic radiation source is positioned to illuminate the nanowires and the substrate such that the electromagnetic radiation is transmitted through the substrate and reflected off a reflective layer into the nanowires.

15. The system of claim 8 wherein the electromagnetic radiation source is positioned to illuminate the substrate such that the electromagnetic radiation is transmitted through the substrate and into the nanowires.
